(19) United States
(12) Patent Application Publication
(10) Pub. No.: US 2008/0022888 A1
(43) Pub. Date: Jan. 31, 2008

(54) Ready to use combined skin marking stain compound and applicator requiring only the addition of water

(75) Inventor: Douglas C. Arndt, Jacksonville, FL (US)

Correspondence Address: Harold L. Jackson, Ste. N, 14751 Plaza Dr., Tustin, CA, 92780, US

(73) Assignee: Armor Holdings Forensics, Inc.

(21) Appl. No.: 11/494,236

(22) Filed: Jul. 27, 2006

(51) Int. Cl. C09D 11/00

(52) U.S. Cl. 106/31.03; 106/31.14; 106/31.16

(57) ABSTRACT

A ready to use skin marking stain/applicator for use in inhibiting voter fraud requiring only the addition of water, includes a open top container with a measured quantity of dry water soluble stain producing compound disposed therein. The compound, when dissolved in water, filling the container, is capable of reacting with the organic materials on the person's finger, to produce within a relatively short time, a semipermanent, highly visible, stain, on the finger. A substantially impermeable removable cover is secured over the open top of the container to inhibit the ingress of moisture into the container prior to its use.

### FIELD OF THE INVENTION

The present invention relates to skin marking stain compounds and an applicator therefore for voter identification purposes to inhibit voter fraud.

### BACKGROUND OF THE INVENTION

Many governments around the world and agencies thereof strive to deter duplicate voting during elections by requiring those casting ballots to immerse a digit such as a finger or thumb into a container of an indelible ink immediately prior to or after voting. The resulting stain enables those monitoring the voting process to identify a person as having previously voted and prevent the person from casting additional ballots. Since the voting process, in many governmental elections, often spans several days it is necessary that the stain remain visible for that period of time and not be readily removable through the use of common soaps, solvents and cleaners, such as bleach.

Staining materials for use in deterring voter fraud have traditionally been supplied as pre-mixed liquids. Such pre-mixed liquids generally include certain dyes, often with the addition of silver nitrate to produce a highly visible, semipermanent stain, e.g., brownish black when silver nitrate is added. A solution containing silver nitrate, while highly visible and capable of remaining so for the duration of time span set for most elections, has several drawbacks, i.e, it is highly poisonous, has a short shelf-life and the resulting stain may be difficult to detect on dark skin. The assignee of this application has marketed an improvement over conventional silver nitrate formulations in the form of an aqueous solution of ninhydrin and rhodamine. This solution is not poisonous, has a reasonable shelf-life and produces a semipermanent blue to purplish stain in about 10 minutes and an immediately visible, less permanent magenta colored stain, to satisfy the person overseeing the marking process that the person has been exposed to the staining solution.

The prior art, for inhibiting individuals from voting more than once, while ready to use, all suffer from certain drawbacks including limited shelf-life and considerable shipping costs which are especially disadvantageous when the product is shipped internationally. In addition, some of the conventional stains include dangerous or otherwise undesirable ingredients such as silver nitrate and/or solvents such as alcohol.

There is a need for a better voter fraud inhibiting product which is not only ready to use, but overcomes the above disadvantages.

### SUMMARY OF THE INVENTION

A ready to use skin marking stain/applicator for use in inhibiting voter fraud and requiring only the addition of water, in accordance with the present invention, includes a suitable container with an open top for accommodating the insertion of a voter's digit such as a thumb or finger. A measured quantity of a dry water-soluble stain producing compound is disposed in the container. The compound, when dissolved, in water filling the container, is capable of reacting with the organic material on the surface of a person's skin and/or nail, to produce within a preselected time frame a semipermanent highly visible stain under ambient and/or ultraviolet (UV) light on the exposed digit. The selected time frame may be within the range of 0 to 10 or more minutes and preferably less than 20 minutes. Preferably a removable cover (e.g., a substantially impermeable one) is disposed over the container top to prevent the egress of moisture into the container interior. The stain producing compound may be in the form of a single component such as a soluble dye or reagent and preferably one that exhibits strong resistance to oxidizing agents such as bleach. The term “dye” as used herein includes dye-based inks.

Optionally, the stain producing compound may comprise two separate components in the form of a relatively water insoluble dye (i.e., only partially soluble) and a dry solublizing chemical material which, when dissolved in water, allows sufficient quantities of the dye to go into solution to provide the desired stain. Another two component dehydrated stain producing compound (sometimes referred to as a reagent) may comprise a color former and developer with the color former and developer reacting in the presence of water to form a staining solution. A third component may be added to provide an immediate visible stain, if necessary, to satisfy an election official that the voter has been exposed to the staining solution. Preferably a stain, e.g., a dye, is selected which will bind strongly to skin residue proteins since the invention is directed to producing a stain on the skin and fingernails of the person's fingers or thumbs.

Proteins are comprised of smaller units called peptides, which are comprised or smaller units, called amino acids. In general, any compound that is amine-ractive will bind to proteinaceous materials (skin, nails, hair). Cationic protein stains are typically categorized as acid dyes because they bind best in acidic environments. Anionic protein stains are categorized as basic dyes because they bind best in basic environments. A further aspect of this invention is the addition of a pouch or pellet to adjust pH of the resulting solution and consequently maximize the power of the stain.

### BRIEF DESCRIPTION OF THE DRAWINGS

FIGS. 1 and 2 are perspective and side elevational views of an applicator which includes a dehydrated water-soluble stain producing compound therein in accordance with the present invention with an installed cover in FIG. 1;

FIG. 3 is a cross-sectional view of the applicator of claim 1 illustrating the compound disposed therein in packet, tablet and capsule form; and

FIG. 4 is a perspective view of the applicators of FIG. 1 filled with water and a fill line designated thereon.

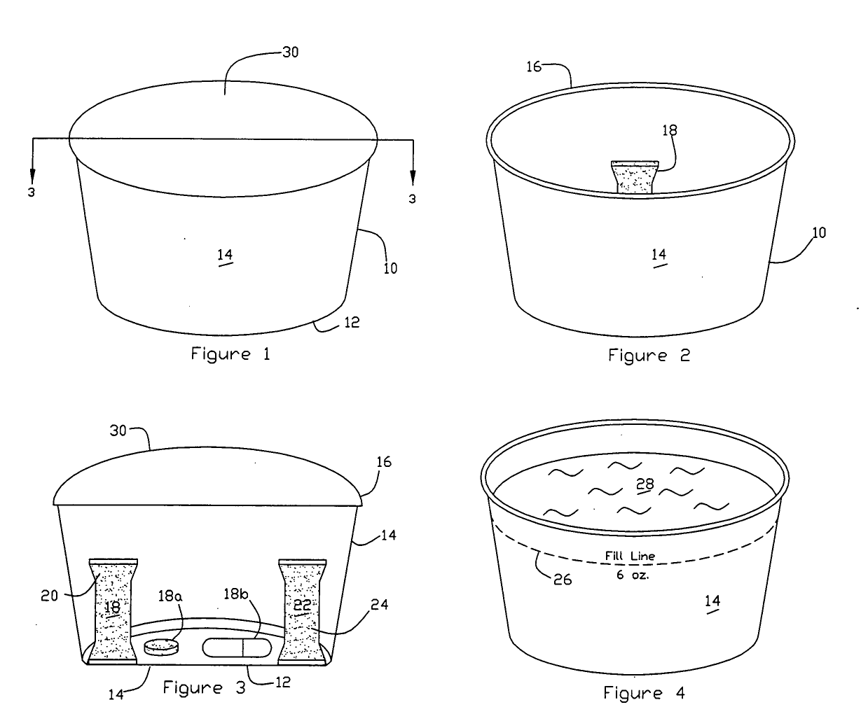

### DESCRIPTION OF THE PREFERRED EMBODIMENT

Referring to the drawing a container 10 made of a suitable plastic, for example, has a bottom wall 12 and a peripheral side wall 14 terminating in a rim 16 defining an open top through which a voter's digit, e.g., finger or thumb, maybe inserted to be stained. Alternatively, the stain may be applied via a brush or the like. A measured quantity of a skin staining compound 18 is disposed in the container within a water-soluble pouch 20. The compound(s) is in its dry or dehydrated state so that when the container is filled with water to approximately the rim or to a designated fill line, the dry or dehydrated compound is dissolved in the water forming a staining solution capable of reacting with the organic materials on an individual's finger, thumb and/or nail to produce a semipermanent, highly visible stain on the exposed digit which is visible under ambient and/or UV light. The resulting stain will remain on the individual's body, e.g, finger or thumb, for a reasonable period of time, e.g., 2-3 days to accommodate the voting process and be substantially nonremovable through the use of common available household products such as soap and bleach during said time frame. The term “measured quantity” as used herein to describe the staining compound shall mean a quantity of the compound which is sufficient to provide the semipermanent stain on the exposed digit when dissolved in the quantity of water 28 filling the container to its top or designated fill line 26. Where two or more compounds are used the term “measured quantity” can refer to the stoichiometric quantity between the two or more ingredients. The term “completely soluble” as used herein to describe the staining compound shall mean a compound or compounds which will directly pass into solution. The term “soluble” as used herein to describe a staining compound shall mean a compound which will pass directly into solution with water, i.e, completely soluble or one, i.e., partially soluble that requires the aid of solubilizer to dissolve in sufficient quantities in water to form the desired staining solution.

Instead of placing the staining compound 18 in a pouch it may be in the form of a tablet or small briquette 18a or capsule 18b disposed within the container. Where a two component staining compound, to be described (or to separate single component compounds), is to be used, one-component may be encapsulated in pouch 20 and the other component 22 may be encapsulated in a separate pouch 24, although such physical separation may not be required. A substantially impermable removable cover, such as a conventional thermoplastic sheet or metallic foil 30, may be placed over the container mouth to inhibit the ingress of moisture into the container interior prior to its use.

The size of container may vary, but I have found that containers holding (or having a fill line designation of 60 ml (2 oz) or 120 ml (4 oz) are readily acceptable in the industry. The size of the container determines the amount of the staining compound required with the caveat that the strength of the resulting solution and the quantity of the staining compound will vary depending upon the desired staining formulation.

### Examples of Suitable Staining Compounds

Single-component dehydrated dyes, suitable for use in the invention, may be either highly colorant (Gentian violet, FD&C Blue #1), invisible but fluorescent (stilbene, naphthalene, and coumarin derivatives) both colorant and fluorescent (Rhodamine-G6), invisible and essentially non-fluorescent until bound with proteins (dansylated compounds) or essentially colorless until bound with proteins (ninhydrin and its analogs).

A two-component dry dye based compound may consist of a fluorescent coumarin derivative generally hydophilic dye, such as Savannah Yellow, and a solubilizer such as caprolactam and dimethyl sulfone. The high molecular weight polyethylene powders may also be used as solubilizer. Single-component reagent stains include ninhydrin, silver sutrate in a water-soluble polyvinyl alcohol structure.

Two-component staining reagents (coated or placed in separated pouches to prevent a reaction prior to the addition of water) may be in the form of a color former, i.e, chromogenic or fluorogenic combination of an intermediate mono-or poly-functional benzene, naphthalene, acridine compound and a developer such as a polyvalent metal ion, mineral or organic acid, oxidizer or an electron-receiving substance. Some examples of such two component staining reagents are listed below:

Color Former Developer
pyrocatechol + vanadium oxysulfate
8-hydroxyquinoline sulfate + ferric sulfate
aminophenol + peroxide
diphenylamine hydrochloride + potassium nitrate
naphthalenediamine dihydrochloride + sodium nitrite
tannic acid + ferric salt
fluorescin + peroxide
acridine hydrochloride + zinc sulfate

A third component in the form of a dye capable of providing an immediate, though less permanent stain, may be added to the single-or double-component compound. Such a dye may be rhodamine (added to ninhydrin).

### Quantative Examples of Staining Compounds and Water Need to Produce the Staining Solution

Single Component Dyes:
a) 1.2 grams Gentian Violet in water-soluble structure
Fill 120-ml container to capacity with tap water
b) 1.8 grams of Basic Violet 10, 500% conc., in water-soluble structure
c) 1.2 grams of DayGlo Color Corp. UV Blue D-282 in water-soluble structure

Fill 120-ml container to capacity with tap water
d) Single-component reagent stains:
e) 1.2 grams ninhydrin in water-soluble structure
Fill 120-ml container to capacity with purified water
f) 6 grams of silver nitrate in water-soluble, opaque, polyvinyl alcohol structure
Fill 60-ml container to capacity using distilled water

Two-component reagents:
a) 2.7 grams ferric chloride hexahydrate in water-soluble structure 1.66 grams of pyrocatechol in another water-soluble structure Fill 60-ml container to capacity using tap water
b) 2.7 grams ferric chloride hexahydrate in water-soluble structure 17 grams of tannic acid in another water-soluble structure Fill 60-ml container to capacity using tap water

Combined Slow and Fast Acting Dyes:
1 gram ninhydrin in water-soluble structure dissolvable in 3-5 seconds
1.8 grams of Basic Violet 10 in water-soluble structure dissolvable in 10-20 seconds
1 gram of Victoria Pure Blue Base in another water-soluble structure dissolvable in 10-20 seconds

Fill 120-ml container to capacity using purified water

There has been described a ready-to-use skin marking stain and applicator requiring only the addition of water. The dry, stain-producing compound carried by the applicator prior to the addition of water has a long shelf-life and is lightweight for shipping purposes. The resulting stain on a person's digit is not readily removable for several days enabling those monitoring the election to readily identify those that have previously participated in the event, thereby inhibiting voter fraud.

What is claimed is:

1. A ready-to-use skin marking stain and applicator for inhibiting voter fraud, requiring only the addition of water comprising:
a) a container of a selected volumetric size with an open top adapted to be filled with water; and
b) a measured quantity of a dry water-soluble stain producing compound, capable, when in an aqueous solution, of reacting with the organic material(s) existing on the surface of a person's skin/nails to produce within a selected time frame a semipermanent, highly visible stain under ambient and/or ultraviolet light on a selected portion of the person's body, disposed in the container.

2. The invention of claim 1 wherein the selected time frame is within the range of 0 to 20 minutes.

3. The invention of claim 1 further including a substantially impermeable removable cover secured over the open top of the container to inhibit the ingress of moisture into the container prior to its use.

4. The invention of claim 1 wherein the stain producing compound is contained within a water-soluble pouch.

5. The invention of claim 1 wherein the stain producing compound is in tablet form.

6. The invention of claim 1 wherein the stain producing compound is in capsule form.

7. The invention of claim 1 wherein the stain producing compound is a completely soluble dye.

8. The invention of claim 1 wherein the stain producing compound is a two-component dye in the form of a partially soluble dye and a solublizing agent.

9. The invention of claim 1 wherein the stain producing compound is a single-component reagent.

10. The invention of claim 1 wherein the stain producing compound is a two-component reagent.

11. The invention of claim 1 further including a second dehydrated stain producing compound which, in an aqueous solution, produces a highly visible stain on the selected body portion substantially immediately.

12. The invention of claim 7 wherein the dye is selected from the group consisting of one or more of the following compounds:
Gentian violet, FD&C Blue #1, Basic Violet, UV Blue D-282, stilbene, naphthalene, coumarin derivatives, Rhodamine-G6, dansylated compounds and ninhydrin and its analogs.

13. The invention of claim 9 wherein the reagent selected from the group consisting of ninhydrin and silver nitrate.

14. The invention of claim 10 wherein the coupled reagent is selected from one or more of the group consisting of:
Color Former Developer
pyrocatechol+vanadium oxysulfate
8-hydroxyquinoline sulfate+ferric sulfate
aminophenol+peroxide
diphenylamine hydrochloride+potassium nitrate
naphthalenediamine dihydrochloride+sodium nitrite
tannic acid+ferric salt
fluorescin+peroxide
acridine hydrochloride+zinc sulfate

15. A ready to use skin staining compound and applicator requiring only the addition of water for identifying an individual participating in or attending an event through placing a stain on a portion of the individual's body comprising:
a) a container capable of holding a selected volume of water, the container having a bottom and peripheral wall terminating in a rim surrounding an open top;
b) a measured quantity of a dry water-soluble stain producing compound disposed in the container, the compound, when dissolved in water filling the container, being capable of reacting with the organic material(s) present on an individual's skin to produce a highly visible stain under ambient and/or UV light on the selected individual's skin portion exposed to the solution.

16. The invention of claim 15 further including a substantially impermeable, removable cover secured to the container rim to inhibit the ingress of moisture into the container.

17. The invention of claim 16 wherein the stain producing compound is a completely soluble reagent.

18. The invention of claim 16 wherein the staining compound is a two-component reagent.

19. The invention of claim 16 wherein the staining compound comprises a partially soluble dye and a hydrophilic solublizing agent.

20. The invention of claim 17 further including a completely soluble dye disposed in the container which when passed into the solution is capable of producing a stain of the selected body portion substantially immediately.

21. The invention of claim 18 further including a completely soluble dye disposed in the container which when passed into the solution is capable of producing a stain of the selected body portion substantially immediately.

22. The invention of claim 19 further including a completely soluble dye disposed in the container which when passed into the solution is capable of producing a stain of the selected body portion substantially immediately.
